(19) United States
(12) Patent Application Publication
(10) Pub. No.: US 2020/0232856 A1
(43) Pub. Date: Jul. 23, 2020

(54) HIGH-RESOLUTION TEMPERATURE SENSOR BASED ON EXTERNAL SAC AND FIXED-WAVELENGTH LIGHT SIGNAL

(71) Applicant: Shenzhen University, Shenzhen, Guangdong (CN)

(72) Inventors: Zhengbiao Ouyang, Shenzhen, Guangdong (CN); Zhiliang Chen, Shenzhen, Guangdong (CN)

(21) Appl. No.: 16/485,095

(22) PCT Filed: Nov. 21, 2016
(86) PCT No.: PCT/CN2016/106684

§ 371 Date: Aug. 9, 2019

(30) Foreign Application Priority Data
Feb. 15, 2016 (CN) 201610085877.4

(51) Int. Cl. G01K 11/00; G01K 5/14

(52) U.S. Cl. CPC G01K 11/00; G01K 5/14

(57) ABSTRACT

A high-resolution temperature sensor based on an external sac and a fixed wavelength includes an external sac, a metal block, two waveguides, two metal films and a signal light; the external sac is connected with the first waveguide, the metal block is disposed in the first waveguide, and is movable; the first waveguide is connected with a second waveguide; and the signal light has a fixed wavelength.

### CROSS-REFERENCE TO RELATED APPLICATIONS

This application is a Continuation of Application No. PCT/CN2016/106684, filed on Nov. 21, 2016, and claims priority to Chinese Patent Application No. 201610085877.4, filed on Feb. 15, 2016. The entire contents of which are hereby incorporated by reference.

### TECHNICAL FIELD

The present disclosure is related to an high-resolution temperature sensor based on an external sac and single-wavelength laser detection.

### BACKGROUND

Temperature sensors are one of the most widely used sensors in the real world. From the thermometers in our daily lives, to thermometers in large instruments and temperature control devices on integrated circuits, temperature sensors are everywhere. Traditional temperature sensors, such as thermal resistors, platinum resistors, and bimetal switches, have their own advantages, but are no longer suitable for use in miniature and high precision products. Semiconductor temperature sensors have high sensitivity, high resolution, low power consumption, and strong anti-interference ability, making them widely used in semiconductor integrated circuits.

The waveguide based on surface plasmon polariton (SPP) is break through the diffraction limit and realize optical information processing and transmission on the nanometer scale. Surface plasmon polaritons are surface electromagnetic waves that propagate on the surface of a metal when an electromagnetic wave is incident on the interface between the metal and a medium. According to the nature of the surface plasmon polaritons (SPPs), many devices based on simple SPP structures have been proposed, such as filters, circulators, logic gates, and optical switches. These devices are relatively simple in structure and very convenient for optical circuit integration.

### SUMMARY

The object of the present disclosure is to overcome the deficiencies of the existing temperature sensor in resolution and size, and to provide a high resolution temperature sensor that facilitates the integration of the metal-insulator-metal structure.

The object of the present disclosure is achieved by the following technical solutions.

The high-resolution temperature sensor based on an external sac and a fixed-wavelength light signal of the disclosure includes an external sac, a metal block, two waveguides, two metal films and a signal light; the external sac is connected with the first waveguide, the metal block is disposed in the first waveguide, and is movable;

the first waveguide is connected with a second waveguide; and the signal light has a fixed wavelength.

Inside the external sac is a high thermal-expansion-coefficient material.

Inside the external sac is ethanol, or mercury.

A shape of cross section of the external sac is a rectangle, a square, a circle, or an ellipse.

The metal block is gold, or silver; and the metal block is silver.

The metal block has an initial position of 116 nm.

The first and the second waveguide are waveguides of a metal-insulator-metal (MIM) structure.

A medium in the second waveguide is air.

The signal light is a single-wavelength laser having a wavelength of 792 nm.

Compared with the prior art, the present disclosure has the following positive effects:

The temperature sensor is compact in structure, small in size, and very easy to integrate; the temperature sensor has an average temperature resolution of 0.99×10⁻⁹° C., and the temperature resolution is better than 0.595×10⁻⁹° C.

These and other objects and advantages of the present disclosure will become readily apparent to those skilled in the art upon reading the following detailed description and claims and by referring to the accompanying drawings.

### DETAILED DESCRIPTION OF THE DRAWINGS

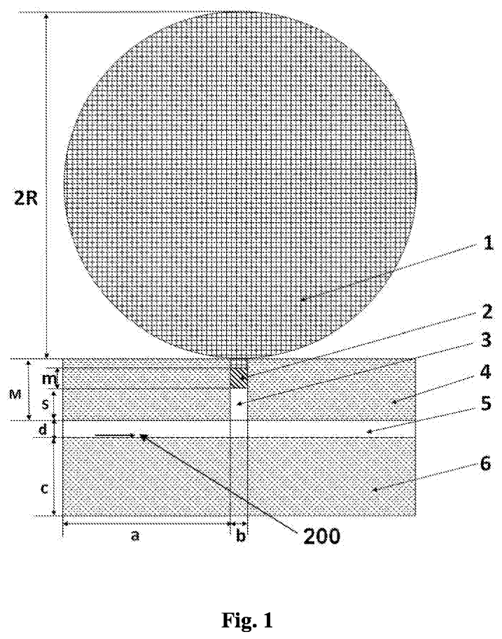

FIG. 1 is a schematic view showing the two-dimensional structure of a first high resolution temperature sensor.

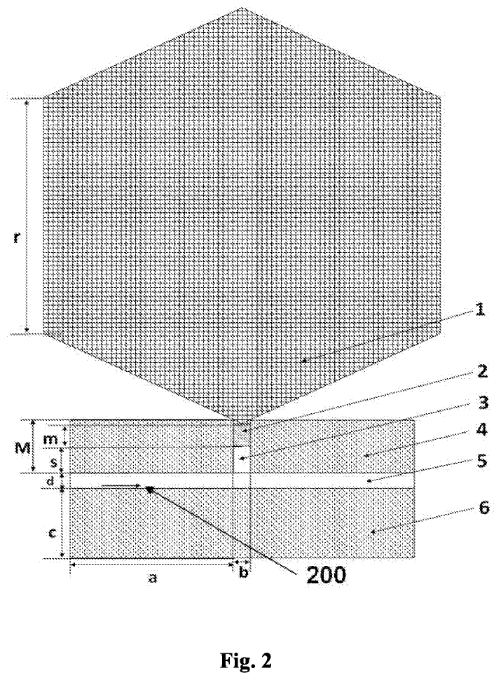

FIG. 2 is a two-dimensional structural diagram of a second high resolution temperature sensor.

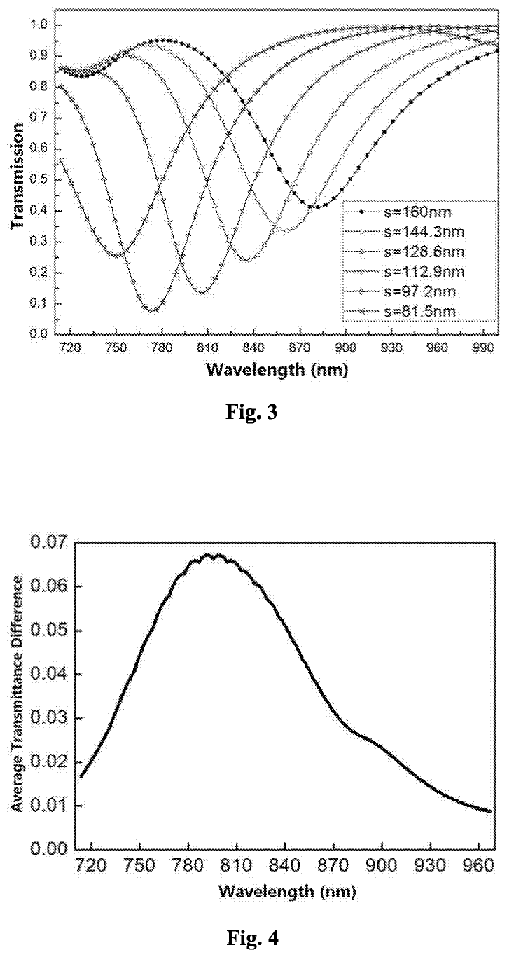

FIG. 3 is a transmission spectrum diagram of signal light of different wavelengths.

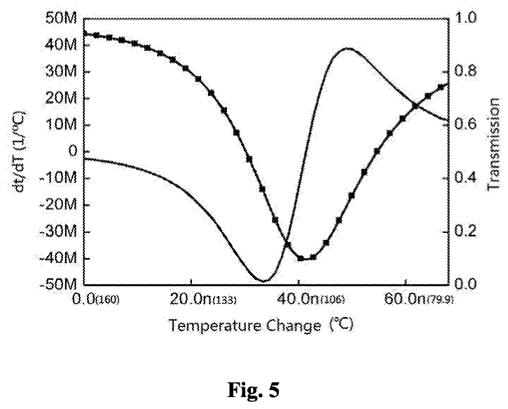

FIG. 4 is the average of the intervals of transmittance for different wavelengths.

FIG. 5 is a graph showing the derivative of the transmittance corresponding to temperature.

The present disclosure is more specifically described in the following paragraphs by reference to the drawings attached only by way of example.

### DETAILED DESCRIPTION

The terms a or an, as used herein, are defined as one or more than one. The term plurality, as used herein, is defined as two or more than two. The term another, as used herein, is defined as at least a second or more.

As shown in FIG. 1, the high-resolution temperature sensor of the present disclosure includes an external sac 1, a metal block 2, a first waveguide (or a vertical waveguide) 3, a metal film 4 (not etched), a second waveguide (or a horizontal waveguide) 5, a metal film 6 (not etched), and a signal light (or a horizontally propagated signal light) 200; the external sac 1 is connected with the first waveguide 3, the external sac 1 is a spherical, the radius R is 0.1 mm, and a material in the external sac 1 has a relatively lower heat capacity with a higher thermal-expansion-coefficient, and is ethanol, or mercury, preferably ethanol; the metal films 4 and 6 are gold, or silver, and are made of silver, and the thickness h₁ of the metal films 4 and the 6 are respectively 100 nm; the range of thickness h₁ is 100 nm; the metal block 2 is disposed in the first waveguide 3, and is movable; the length m of the metal block 2 is 80 to 150 nm, and the range of m is 125 nm; the space length between the metal block 2 and the second waveguide 5 is s, and the range of s is 0 to 200, and is determined by the position of the metal block 2; the metal block 2 is gold, or silver, and uses silver; the first waveguide 3 is connected with the second waveguide 5; the first waveguide 3 and the second waveguide 5 are waveguides of a metal-insulator-metal (MIM) structure; the insulator is made of a non-conductive transparent material; and is air, silicon dioxide, or silicon (Si); the first waveguide 3 is located at the upper end of the second waveguide 5; the width b of the first waveguide 3 is in the range of 30 to 60 nm, and the width b of the first waveguide 3 is 35 nm; the length M of the first waveguide 3 is greater than 200 nm, and the length M is 300 nm; the distance a from the left edge of the first waveguide 3 to the left edge of the metal film 6 is 400 nm, and the range of a is 350 to 450 nm; the width d of the second waveguide 5 is in the range of 30 to 100 nm, the width d is 50 nm, and the medium in the second waveguide 5 is air; the distance from the lower edge of the second waveguide 5 to the lower edge of the metal film 6 is c, and c is greater than 150 nm; the signal light 200, it propagates along the waveguide surface and forms the surface plasmon polaritons (SPPs) has a fixed wavelength, and is a laser with a wavelength of 792 nm.

In the present disclosure, the volume of ethanol is changed by temperature, causing the ethanol to expand and push the metal block 2 to move toward the second MIM waveguide 5 to change the length of the air segment in the first waveguide 4, and the metal block 2 moves downward, so that the length of the second waveguide 5 changes, and the transmittance of the signal light 200 (i.e., the light signal) changes accordingly. Since the movement of the metal block 2 is controlled by temperature, the change of temperature affects the change of the transmittance of the signal light 200, and thus in accordance with the transmittance change one can detect the change of temperature; the characteristic of the transmittance corresponds to the temperature one by one (i.e., the change of the temperature is known from the characteristic of the transmittance). When the temperature drops back to its initial value, under the action of the external atmospheric pressure, the metal block 2 will return to its initial pressure-balanced position, which is convenient for the next detection.

The volume-expansion coefficient of ethanol in the external sac 1 of the present disclosure is αₑₜₕₐₙₒₗ=1.1×10⁻³/° C., and the density of ethanol at room temperature (20° C.) is ρ=0.789 g/cm³. The linear expansion coefficient of metal block 2 is α_{Ag}=19.5×10⁻⁶/° C. Compared to the expansion of ethanol, the expansion of metal block 2 is negligible at the same temperature change. Therefore, in the present disclosure, the influence of temperature changes on the volume of metal block 2 is no longer considered. In accordance with the volume of the external sac 1 and the cross-sectional area of the metal block 2, the relationship between the position change of the metal block 2 and the temperature is calculated, thereby defining a proportional coefficient σ indicating the moving distance of the metal block 2 corresponding to the change of unit temperature:

$$σ = \frac{V \times {α}_{ethanol}}{b \times {h}_{1}} = \frac{4 \times π \times {R}^{3} \times {α}_{ethanol}}{3 \times b \times {h}_{1}} \qquad ( 1 )$$

This formula can also be used as a measure of the temperature sensitivity of the structure. In accordance with the formula, it is concluded that the cross-sectional area of the circular external sac 1 and the width of the metal block 2 have a relatively large influence on the positional change of the metal block 2. Comprehensively, b=35 nm is considered, obtaining a σ=1.32×10⁻⁹ nm/° C., which is the relationship between the amount of movement of the metal block 2 and temperature.

As shown in FIG. 2, the high-resolution temperature sensor of the present disclosure includes an external sac 1, a metal block 2, a first waveguide (or a vertical waveguide) 3, a metal film 4 (not etched), a second waveguide (or a horizontal waveguide) 5, a metal film 6 (not etched), and a signal light (or a horizontally propagated signal light) 200; the external sac 1 is connected with the first waveguide 3, the external sac 1 is a cross section shape of regular hexagon, the side length r is 0.1 mm, and a material in the external sac 1 has a relatively lower heat capacity with a thermal-expansion-coefficient, and is ethanol, or mercury, preferably ethanol; the metal films 4 and 6 are gold, or silver, and are made of silver, and the thickness h₁ of the metal films 4 and 6 are respectively 100 nm; the range of thickness h₁ is greater than 100 nm; the metal block 2 is disposed in the first waveguide 3, and is movable; the length m of the metal block 2 is 80 to 150 nm, and the range of length m is 125 nm; the space length between the metal block 2 and the second waveguide 5 is s, and the range of s is 0 to 200 nm, and is determined by the position of the metal block 2; the metal block 2 is gold, or silver, and uses silver; the first waveguide 3 is connected with the second waveguide 5; the first waveguide 3 and the second waveguide 5 are waveguides of a metal-insulator-metal (MIM) structure; the insulator is made of a non-conductive transparent material, and is air, silicon dioxide, or silicon (Si); and the first waveguide 3 is located at the upper end of the second waveguide 5; the width b of the first waveguide 3 is in the range of 30 to 60 nm, and the width b of the first waveguide 3 is 35 nm; the length M of the first waveguide 3 is greater than 200 nm, and the length M is 300 nm; the distance a from the left edge of the first waveguide 3 to the left edge of the metal film 6 is 400 nm, and the range of a is 350 to 450 nm; the width d of the second waveguide 5 is in the range of 30 to 100 nm, the width d is 50 nm, and the medium in the second waveguide 5 is air; the distance from the lower edge of the second waveguide 5 to the lower edge of the metal film 6 is c, and c is greater than 150 nm; the signal light 200, it propagates along the waveguide surface and forms the surface plasmon polaritons (SPPs) has a fixed wavelength, and is a laser with a wavelength of 792 nm.

In the present disclosure, the volume of ethanol is changed by temperature, causing the ethanol to expand and push the metal block 2 to move toward the second MIM waveguide 5 to change the length of the air segment in the first waveguide 4, and the metal block 2 moves downward so that the length of the second waveguide 5 changes, and the transmittance of the signal light 200 changes accordingly. Since the movement of the metal block 2 is controlled by the temperature, the change of the temperature affects the change of the transmittance of the signal light 200, and thus in accordance with the transmittance change one can detect the change of temperature; the characteristic of the transmittance corresponds to the temperature one by one (i.e., the change of the temperature is known from the characteristic of the transmittance). As the temperature drops back to its initial value, under the action of the external atmospheric pressure, the metal block 2 will return to its initial pressure-balanced position, which is convenient for the next detection.

The metal block 2 is moved downward to change the space length between the metal block 2 and the second waveguide 5, and the transmittance of the signal light 200 (i.e., the light signal) changes accordingly. FIG. 3 shows the transmittance of light at wavelength in the range of 700 to 1000 nm, for different value of s. The initial position of the metal block 3 is the position at the initial temperature, for example, 20° C., and the value of the metal block 2 is s=160 nm; scanning with simulation software one can obtain the transmittance difference at each wavelength of light in the second waveguide 5 for a fixed temperature change of 2.97×10⁻⁹° C.; changing the temperature successively with the fixed temperature step of 2.97×10⁻⁹° C. at the fixed wavelength, calculating the transmittance difference accordingly, one obtains a number of transmittance difference at the fixed wavelength; averaging the transmittance differences at the fixed wavelength, then, the change value of the transmittance for a unit temperature change at a fixed wavelength is obtained; repeating the above process at each wavelength, one obtains the result in FIG. 4. The curve in the figure represents the average value of transmittance change at each wavelength for the scanning of temperature with temperature step of 2.97×10⁻⁹° C. FIG. 4 shows that, the transmittance change has a maximum value of 0.067207 at the wavelength of 792 nm. Therefore, the signal light 200 (i.e., the light signal) of the second waveguide 5 is chosen as a single light source of 792 nm; the change of the temperature affects the change of the transmittance of the signal light 200, and the change of the temperature is detected in accordance with the change of the transmittance.

For the detector having a resolution of 2% for a single wavelength transmittance, the average resolution of the temperature sensor designed by this detection method is 0.99×10⁻⁹° C. For larger volume of the external sac 1, the metal block 2 becomes more sensitive to temperature; in the case where the incident signal light 200 (i.e., light signal) is 792 nm, the transmittance at different temperatures is scanned, and the scanning temperature step is 1.189×10⁻⁹° C., and the scanning result is shown by a black dot curve in FIG. 5. For the transmittance of 792 nm signal light at different temperatures, the signal transmission curve is differentiated to find dt/dT, (i.e., the curve showing the derivative of transmittance with respect to temperature versus temperature). In accordance with the black solid-line curve, maximum transmittance change rate is seen at the position of s=116 nm. In accordance with the temperature scanning step, the temperature resolution of the temperature sensor at this position is calculated as 0.595×10⁻⁹° C., which is the resolution of the temperature sensor at a fixed temperature point. Then the curve is differentiated to find dt/dT (i.e., the curve showing the derivative of transmittance with respect to temperature versus temperature). The curve obtained is shown in the black solid-line curve in FIG. 5. The position of the metal block 2 corresponding to the temperature point is also marked on the horizontal axis for convenient checking of the position corresponding to maximum transmittance change. In accordance with the black solid-line curve, maximum transmittance change rate is seen at the position of s=116 nm. In accordance with the temperature scanning step, the temperature resolution of the temperature sensor at the position is calculated as 0.595×10⁻⁹° C.

In practical applications, the measurement at the vicinity of a fixed temperature point allows the metal block 2 to be initially at 116 nm, and that a high sensitivity or high resolution measurement at a fixed temperature point is achieved.

While the disclosure has been described in terms of various specific embodiments, those skilled in the art will recognize that the disclosure is practiced with modification within the spirit and scope of the claims.

What is claimed is:

1. A high-resolution temperature sensor based on an external sac and a fixed-wavelength light signal includes an external sac, a metal block, two waveguides, two metal films and a signal light; the external sac is connected with the first waveguide; the metal block is disposed in the first waveguide, and is movable; the first waveguide is connected with a second waveguide; and the signal light has a fixed wavelength.

2. The high-resolution temperature sensor based on an external sac and a fixed-wavelength light signal according to claim 1, wherein inside the external sac is a high thermal-expansion-coefficient material.

3. The high-resolution temperature sensor based on an external sac and a fixed-wavelength light signal according to claim 1, wherein inside the external sac is ethanol, or mercury.

4. The high-resolution temperature sensor based on an external sac and a fixed-wavelength light signal according to claim 1, wherein a shape of cross section of the external sac is a rectangle, a square, a circle, or an ellipse.

5. The high resolution temperature sensor based on an external sac and a fixed-wavelength light signal according to claim 1, wherein the metal block is gold, or silver.

6. The high-resolution temperature sensor based on an external sac and a fixed-wavelength light signal according to claim 5, wherein the metal block is silver.

7. The high-resolution temperature sensor based on an external sac and a fixed-wavelength light signal according to claim 1, wherein the metal block has an initial position of 116 nm.

8. The ultra-high resolution temperature sensor based on an external sac and a fixed wavelength according to claim 1, wherein the first and the second waveguide are waveguides of a metal-insulator-metal (MIM) structure.

9. The high-resolution temperature sensor based on an external sac and a fixed-wavelength light signal according to claim 1, wherein a medium in the second metal-insulator-metal waveguide is air.

10. The high-resolution temperature sensor based on an external sac and a fixed-wavelength light signal according to claim 1, wherein the signal light is a single-wavelength laser having a wavelength of 792 nm.
